(19) United States
(12) Patent Application Publication
(10) Pub. No.: US 2025/0304484 A1
(43) Pub. Date: Oct. 2, 2025

(54) METHODS OF SUPPORTING A RIBBON

(71) Applicant: CORNING INCORPORATED, Corning, NY (US)

(72) Inventors: James William Brown, The Villages, FL (US); Cyuan-Si Shih, Painted Post, NY (US)

(21) Appl. No.: 18/707,985

(22) PCT Filed: Nov. 1, 2022
(86) PCT No.: PCT/US2022/048572

§ 371 Date: May 7, 2024

Related U.S. Application Data
(60) Provisional application No. 63/280,204, filed on Nov. 17, 2021.

(51) Int. Cl. C03B 35/14; B25J 15/06

(52) U.S. Cl. CPC C03B 35/145; B25J 15/0683

(57) ABSTRACT

Methods can include controlling a support device while supporting a ribbon. The method can include controlling the support device to maintain a downward force (Fₓ) in a direction of an X-axis within a first range of forces. The method can further include controlling the support device to provide a force profile (F_{z}) in a direction of aZ-axis that reduces a moment (Mₓ) about the X-axis. The method can further include controlling the support device to reduce a force differential (F_{y}) in the direction of the Y-axis that reduces a moment (M_{z}) about the Z-axis.

### CROSS-REFERENCE TO RELATED APPLICATIONS

This application claims the benefit of priority under 35 U.S.C. § 119 of U.S. Provisional Application Ser. No. 63/280,204, filed on Nov. 17, 2021, the content of which is relied upon and incorporated herein by reference in its entirety.

### FIELD

The present disclosure relates generally to methods of supporting a ribbon and, more particularly, to methods of supporting a ribbon by gripping the ribbon with a support device.

### BACKGROUND

Display devices include liquid crystal displays (LCDs), electrophoretic displays (EPD), organic light-emitting diode displays (OLEDs), plasma display panels (PDPs), or the like. Display devices can be part of a portable electronic device, for example, a consumer electronic product, a smartphone, a tablet, a wearable device, or a laptop.

It is known to form a ribbon from a quantity of molten material at a location upstream from where the ribbon is gripped with the support device. Once the ribbon is gripped by the support device, the ribbon can then be separated with the separated portion of the ribbon being gripped by the support device for storage or further processing. It is known to further divide the ribbon into individual display ribbons for incorporating into one or more of the above-referenced display devices.

The process of separating the ribbon that is being formed from the quantity of molten material can result in undesired movement of the ribbon and/or undesired disturbances traveling up the ribbon into the viscous zone. Such disturbances in the viscous zone can result in imperfections being permanently frozen into the ribbon as it cools from the viscous zone to the elastic zone. The disturbances can further cause force spikes that can result in undesired wear on the pull rolls.

There is a need to provide improved processing techniques that minimize imperfections from being frozen into the ribbon when handling the ribbon with a support device. There is also a need to provide improve processing techniques that will minimize wear of the pull rolls while supporting the ribbon with the support device.

### SUMMARY

There are set forth herein methods of supporting a ribbon that provides improved handling of the ribbon with a support device while separating the ribbon being formed from a quantity of molten material. The improved handling can reduce undesired disturbances from traveling up the ribbon; thereby reducing imperfections in the cooled ribbon and reducing wear on the pull rolls.

In some aspects, methods are provided for supporting a ribbon extending along a direction of an X-axis and along a direction of a Y-axis perpendicular to the direction of the X-axis. The method comprises gripping the ribbon with a support device. The method further comprises controlling the support device to maintain a downward force (Fₓ) in the direction of the X-axis within a first range of forces, wherein the downward force (Fₓ) is applied by the support device to the ribbon. The method still further comprises controlling the support device to provide a force profile (F_{z}) in a direction of a Z-axis that is perpendicular to the direction of the X-axis and the direction of the Y-axis, wherein the force profile (F_{z}) is applied by the ribbon to a nosing device across a width of the ribbon, and wherein controlling the support device to provide the force profile (F_{z}) further reduces a moment (Mₓ) about the X-axis. The method further comprises controlling the support device to reduce a force differential (F_{y}) in the direction of the Y-axis, wherein the force differential (F_{y}) is applied to the ribbon by the support device across the width of the ribbon, wherein controlling the support device to reduce the force differential (F_{y}) further reduces a moment (M_{z}) about the Z-axis, wherein the controlling the support device to provide the force profile (F_{z}) in the direction of the Z-axis and the controlling the support device to reduce the force differential (F_{y}) in the direction of the Y-axis are conducted simultaneously and after the controlling the support device to maintain the downward force (Fₓ) in the direction of the X-axis.

In some aspects, the support device further comprises at least one sensor, and the method comprises sensing one or more operating conditions comprising at least one of the downward force (Fₓ), the force profile (F_{z}), the force differential (F_{y}), the moment (Mₓ) about the X-axis, or the moment (M_{z}) about the z-axis with the at least one sensor. The method further comprises controlling the support device in response to the one or more sensed operating conditions to facilitate at least one of controlling the support device to: maintain the downward force (Fₓ), provide the force profile (F_{z}), reduce the force differential (F_{y}), reduce the moment (Mₓ), or reduce the moment (M_{z}).

In some aspects, controlling the support device to maintain the downward force (Fₓ) comprises controlling a movement of the support device in accordance with the equation:

$$M \ddot{x} + {B}_{x} \dot{x} + {K}_{x} x = {F}_{x} - ( {F}_{p u l {l}_{x 1}} + {F}_{p u l {l}_{x 2}} ) - {F}_{r o o t} - ( {F}_{m s {r}_{1}} + {F}_{m s {r}_{2}} ) sin θ - ( {F}_{n o s e} + {F}_{{nose}^{′}} ) sin θ + ( W ) cos θ ,$$

wherein the meaning of the terms of the equation are provided later in the application.

In some aspects, controlling the support device to reduce the force differential (F_{y}) comprises controlling movement of the support device in accordance with the equation:

$$M \ddot{y} + {B}_{y} \dot{y} + {K}_{y} y = {F}_{y} + {F}_{p u l {l}_{y 1}} + {F}_{p u l {l}_{y 2}}$$

wherein the meaning of the terms of the equation are provided later in the application.

In some aspects, controlling the support device to provide the force profile (F_{z}) comprises controlling a movement of the support device in accordance with the equation:

$$M \ddot{z} + {B}_{z} \dot{z} + {K}_{z} z = {F}_{z} + ( {F}_{m s {r}_{1}} + {F}_{m s {r}_{2}} ) cos θ + ( {F}_{{nose}^{′}} + {F}_{n o s e} ) cos θ + W sin θ ,$$

wherein the meaning of the terms of the equation are provided later in the application.

In some aspects, controlling the support device to reduce the moment (Mₓ) comprises controlling a movement of the support device in accordance with the equation:

$${I}_{x x} \ddot{ϕ} + {B}_{ϕ} \dot{ϕ} + {K}_{ϕ} ϕ = {M}_{x} + ( {F}_{m s {r}_{1}} {d}_{1} cos θ - {F}_{m s {r}_{2}} {d}_{1}^{′} cos θ ) - ( {F}_{p u l {l}_{y 1}} {d}_{3} + {F}_{p u l {l}_{y 2}} {d}_{3}^{′} ) + ( {F}_{n o s e} {d}_{5} cos θ - {F}_{{nose}^{′}} {d}_{5}^{′} cos θ ) - W {h}_{3} sin θ ,$$

wherein the meaning of the terms of the equation are provided later in the application.

In some aspects, the controlling the support device to reduce the moment (M_{z}) comprises controlling a movement of the support device in accordance with the equation:

$${I}_{zz} \ddot{ψ} + {B}_{ψ} \dot{ψ} + {K}_{ψ} ψ = {M}_{z} + ( {F}_{p u l {l}_{y 1}} {d}_{2} + {F}_{p u l {l}_{y 2}} {d}_{2}^{′} ) + ( {F}_{p u l {l}_{x 1}} {d}_{1} - {F}_{p u l {l}_{x 2}} {d}_{1}^{′} ) + {F}_{n o s e} {d}_{5} sin θ - {F}_{{nose}^{′}} {d}_{5}^{′} sin θ - {F}_{r o o t} {d}_{0} + ( W {h}_{3} cos θ ) ,$$

wherein the meaning of the terms of the equation are provided later in the application.

In some aspects, the first range of forces of the downward force (Fₓ) is from about 5 Newtons to about 70 Newtons.

In some aspects, the force profile (F_{z}) is within a second range of forces from about 3 Newtons to about 5 Newtons.

In some aspects, the gripping the ribbon with the support device comprises removably attaching the support device to the ribbon with a plurality of suction cups.

In some aspects, the plurality of suction cups comprises a first plurality of suction cups engaging a first lateral side of the ribbon and a second plurality of suction cups engaging a second lateral side of the ribbon opposite the first lateral side.

In some aspects, the method further comprises placing the ribbon in tension across a width of the ribbon by biasing the first plurality of suction cups away from the second plurality of suction cups.

In some aspects, the ribbon comprises at least one of a glass-based ribbon or a ceramic-based ribbon.

In some aspects, the method further comprises scoring a major surface of the ribbon across the width of the ribbon and along the nosing device while contacting the ribbon with the nosing device.

In some aspects, the ribbon comprises a thickness of from about 0.2 mm to about 1.5 mm.

In some aspects, the ribbon moves in the direction of the X-axis during the gripping of the ribbon with the support device.

In some aspects, the ribbon is formed from a quantity of molten material at a location upstream from where the ribbon is gripped with the support device.

In even further embodiments, the method can further comprise measuring the feature using the first signal and the second signal

### BRIEF DESCRIPTION OF THE DRAWINGS

The above and other features and advantages of embodiments of the present disclosure are better understood when the following detailed description is read with reference to the accompanying drawings, in which:

FIG. 1 shows a schematic view of a ribbon being formed from a quantity of molten material and a handling device in accordance with aspects of the disclosure;

FIG. 2 is an end view of a gripping device of the handling device for gripping the ribbon along line 2-2 of FIG. 1;

FIG. 3 is a schematic view of features of the support device for handling the ribbon in accordance with aspects of the disclosure;

FIG. 4 is a flow chart demonstrating methods of supporting the ribbon in accordance with aspects of the disclosure;

FIG. 5 is a schematic side view of the support device of FIG. 3 and the ribbon prior to gripping the ribbon with the support device;

FIG. 6 is a schematic side view of the support device of FIG. 5 and the ribbon after gripping the ribbon with the support device;

FIG. 7 is a schematic view of the support device of FIG. 6 illustrating the ribbon being forced against an elongated nosing device with the support device while scoring the ribbon along a width of the ribbon;

FIG. 8 is a schematic view of the support device of FIG. 7 illustrating the handling device separating the ribbon;

FIG. 9 is a schematic view of the support device of FIG. 8 illustrating the handling device supporting the separated portion of the ribbon;

FIG. 10 is a schematic view of the support device gripping the ribbon while maintaining a downward force (Fₓ) in the direction of the X-axis within a first range of forces;

FIG. 11 a schematic view of charts demonstrating a downward force (Fₓ) in the direction of the X-axis using conventional methods compared to methods of the disclosure;

FIG. 12 is a schematic view of the support device gripping the ribbon while providing a force profile (F_{z}) in the direction of the Z-axis and a reduced moment (Mₓ) about the X-axis;

FIG. 13 is a schematic view of charts demonstrating the force profile (F_{z}) in the direction of the Z-axis and the moment (Mₓ) about the X-axis using conventional methods compared to methods of the disclosure;

FIG. 14 is a schematic view of the support device gripping the ribbon in accordance with aspects of the disclosure while reducing a force differential (F_{y}) in the direction of the Y-axis in accordance with aspects of the disclosure;

FIG. 15 is a schematic view of charts demonstrating a force differential (F_{y}) in the direction of the Y-axis using conventional methods compared to methods of the disclosure;

FIG. 16 is a schematic view of the support device gripping the ribbon in accordance with aspects of the disclosure while a moment (M_{z}) about the Z-axis is reduced;

FIG. 17 is a schematic view of charts demonstrating the moment (M_{z}) aboutthe Z-axis using conventional methods compared to methods of the disclosure;

FIG. 18 illustrates plots demonstrating pull roll wear over time when using conventional methods compared to methods of the disclosure; and

FIG. 19 illustrates a chart demonstrating the kinetic energy in the ribbon when using conventional methods compared to methods of the disclosure.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, claims may encompass many different aspects of various embodiments and should not be construed as limited to embodiments set forth herein.

Methods are disclosed herein for supporting a ribbon. In some embodiments, ribbons can comprise glass-based ribbons or ceramic-based ribbons. For purposes of this application ribbons can comprise a ribbon in a viscous state (e.g., immediately after being formed with a forming device), elastic state (e.g., cooled at room temperature), or viscoelastic state (where the ribbon is transitioning from the viscous state to the elastic state. Ribbons can be formed in a wide range of ways such as by down-draw, updraw, press-roll forming, slot draw or other techniques. In such techniques, a quantity of molten material can be drawn, press-rolled or otherwise formed into a ribbon.

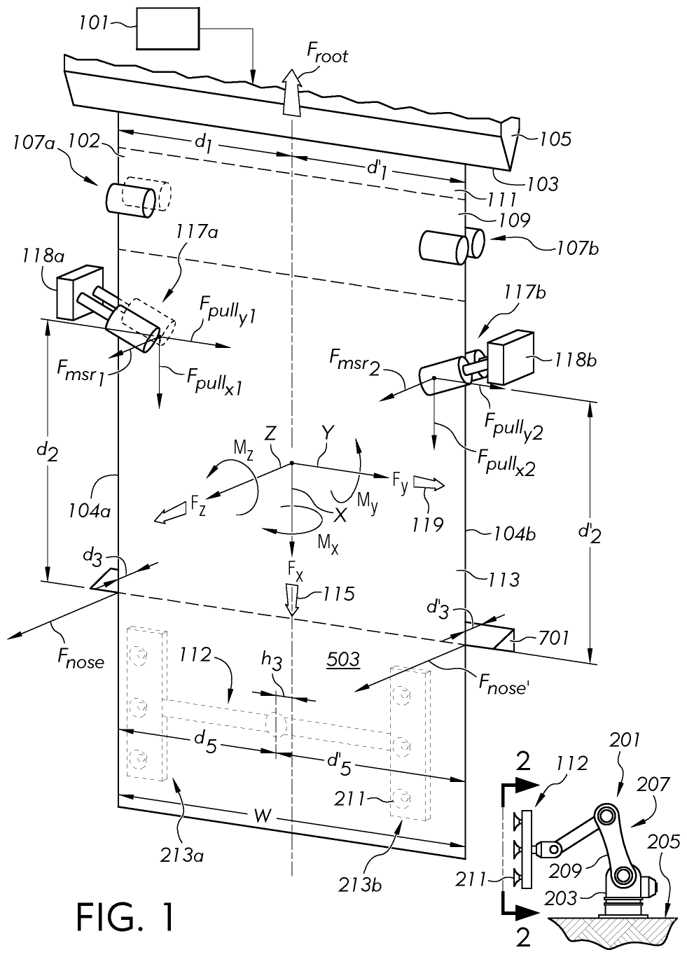

By way of schematic illustration, FIG. 1 illustrates a fusion draw apparatus where a quantity of molten material 101 is fed into a trough (not shown) and fusion drawn into a ribbon 102 from a root 103 of a forming wedge 105 of the fusion draw apparatus. Pairs of stub rolls 107a, 107b can be provided to finish the edges of the ribbon 102, e.g., in a viscoelastic zone 109, positioned downstream in a direction 115 from a viscous zone 111. As shown, the direction 115 can comprise the travel direction of the ribbon 102 being drawn from the root 103 and can also comprise the direction 115 of an X-axis “X”. The fusion draw apparatus can further comprise pairs of pull rolls 117a, 117b that may be driven by motors 118a, 118b to create tension in the ribbon at a location upstream from the pull rolls 117a, 117b to thin the ribbon 102 to the desired thickness “T”. As shown in FIG. 3, the thickness “T” of the ribbon 102 can be the average distance between a first major surface 501 and a second major surface 503 of the ribbon. In some embodiments, the thickness “T” can be in a range of from about 0.2 mm to about 1.5 mm although other thicknesses can be provided in further embodiments. The pairs of pull rolls 117a, 117b can engage the corresponding edges 104a, 104b of the ribbon 102 (as shown) or engage corresponding lateral side portions of the ribbon inboard from a bead at the edge of the ribbon. The pairs of pull rolls 117a, 117b can pull the ribbon 102 within an elastic zone 113 positioned downstream in the direction 115 from the viscoelastic zone 109.

As shown in FIG. 1, the ribbon 102 can extend along the direction 115 of the X-axis “X” that can also comprise the travel direction of the ribbon 102. The ribbon 102 can also extend in a direction 119 of a Y-axis “Y” that is perpendicular to the direction 115 of the X-axis “X”. As such, the ribbon 102 can comprise a substantially planar ribbon that extends both in the direction 115 of the X-axis “X” and also the direction 119 of the Y-axis “Y”. The ribbon comprises a width “W” that extends in the direction 119 of the Y-axis comprising a lateral direction of the ribbon 102 from a first lateral edge 104a at a first side of the ribbon 102 to a second lateral edge 104b at a second side of the ribbon 102.

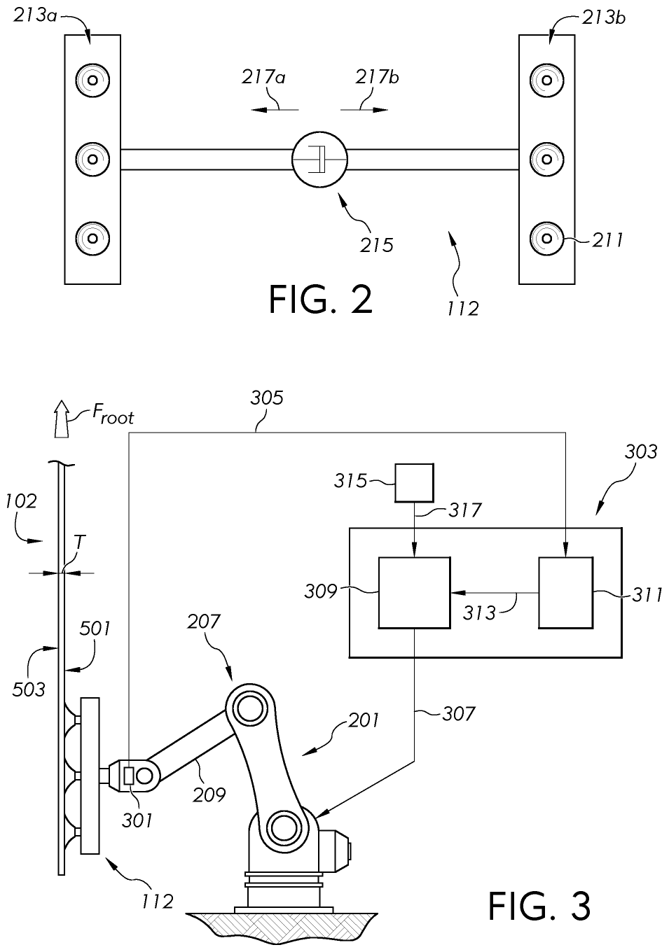

FIG. 1 further schematically illustrates a support device 201 that can comprise a base 203 mounted to a support surface 205. An arm 207 of the support device 201 can have segments 209 designed to permit movement of a gripping device 112 of the support device 201 with six degrees of freedom. The gripping device 112 can comprise a plurality of suction cups 211 designed to be removably attached to the ribbon 102. As shown in FIG. 2, the plurality of suction cups 211 can be arranged as a first plurality of suction cups 213a and a second plurality of suction cups 213b. As shown, aspects of the disclosure can provide the first plurality of suction cups 213a as a first column of suction cups 211 arranged in series. The second plurality of suction cups 213b can be provided as a second column of suction cups 211 arranged in series. FIG. 1 illustrates the gripping device 112 by viewing through the glass as the gripping device 112 engages the opposite major surface 501 of the ribbon 102. As shown in FIG. 1, the ribbon 102 is formed from a quantity of molten material at a location upstream from where the ribbon is gripped with the gripping device 112 of the support device 201. As can be seen, the first and second column are disposed on opposite lateral sides of the ribbon in a direction of the width “W” wherein the first plurality of suction cups 213a engage a first lateral side of the ribbon and the second plurality of suction cups 213b engage a second lateral side of the ribbon opposite the first lateral side. The opposite lateral sides can be removed and discarded after separating the ribbon and releasing the separated portion of the ribbon from the gripping device. Furthermore, as shown schematically in FIG. 2, a tensioning device 215 such as the illustrated hydraulic cylinder can move the first plurality of suction cups 213a laterally away from the second plurality of suction cups 213b in respective opposite directions 217a, 217b to place the ribbon in tension across the width “W” of the ribbon 102.

As shown in FIG. 3, the support device 201 can comprise a sensor 301 that can comprise a multiple axis or multiple degree-of-freedom force sensor, for example, a six-axis force and/or torque sensor (e.g., a six-degrees-of-freedom force sensor) that can sense forces along the X-axis, Y-axis, and Z-axis as well as torques about the X-axis, Y-axis, and Z-axis. The sensor 301 can further comprise programming and/or circuitry that can generate and transmit electrical signals conveying sensed information. In some embodiments, the sensor 301 can comprise a sampling rate of 50 hertz (Hz) or more, 100 Hz or more or other sampling rates.

In some embodiments, the support device 201 can further comprise a control apparatus 303 that can receive data from the sensor 301 and operate the segments 209 of the arm 207. The control apparatus 303 can comprise a control device (e.g., a computer, a programmable logic controller, etc.) configured to (e.g., programmed to, encoded to, designed to, and/or made to) operate the arm 207. For example, the control apparatus 303 may be electrically connected to (e.g., wired or wireless) the sensor 301. In some embodiments, the control apparatus 303 can receive force data 305 from the sensor 301. The control apparatus 303 can also transmit motion instructions 307 to the arm 207. In some embodiments, the control apparatus 303 can comprise one or more controllers, for example a first controller 309 and a second controller 311. In some embodiments, the first controller 309 can control operation of the arm 207 while the second controller 311 can process and/or analyze the force data 305 (e.g., force-related feedback information) from the sensor 301 and generate responsive adjustments for the arm 207. For example, the motion instructions 307 can be transmitted from the first controller 309 to the arm 207 and/or to a separate controller at the arm 207 that controls movement of the segments 209 of the arm 207. The arm 207 can move in response to the motion instructions 307. For example, the motion instructions 307 may specify one or more of a path along which the arm 207 may travel, an acceleration of the arm, a velocity of the arm, a distance to be traveled by the arm, etc. The arm 207 can therefore move in accordance with the motion instructions 307.

The second controller 311 can receive the force data 305 from the sensor 301. For example, the ribbon 102 can exert a force upon the gripping device 112, with the force configured to be sensed by the sensor 301 and transmitted as part of the force data 305 to the control apparatus 303. For example, the force data 305 may comprise the forces that may be sensed along one or more of the X-axis, the Y-axis, the Z-axis, a torque about the X-axis, a torque about the Y-axis, and/or a torque about the Z-axis. The second controller 311 can determine possible adjustments to the operation of the arm 207 such as, for example, changes or adjustments in one or more of a position, a path, a velocity, or acceleration of the gripping device 112. The adjustments determined by the second controller 311 may be based, in part, on the force data 305 received by the second controller 311. In some embodiments, the second controller 311 can transmit these adjustments as adjustment data 313 to the first controller 309. The first controller 309 can receive the adjustment data 313 from the second controller 311 and can incorporate the adjustment data 313 into the motion instructions 307 to the arm 207. In some embodiments, a user can input user-inputted data 317 into the first controller 309 by way of a user interface 315. For example, in some embodiments, the user-inputted data 317 can represent the motion instructions 307 for the arm 207 during a first operational cycle of the arm 207, where the user-inputted data 317 can comprise one or more of the initial position, an initial path, an initial velocity, and/or an initial acceleration of the gripping device 112. In some embodiments, the motion instructions 307 can subsequently be changed based on the force data 305, such that the user-inputted data 317 may no longer be implemented.

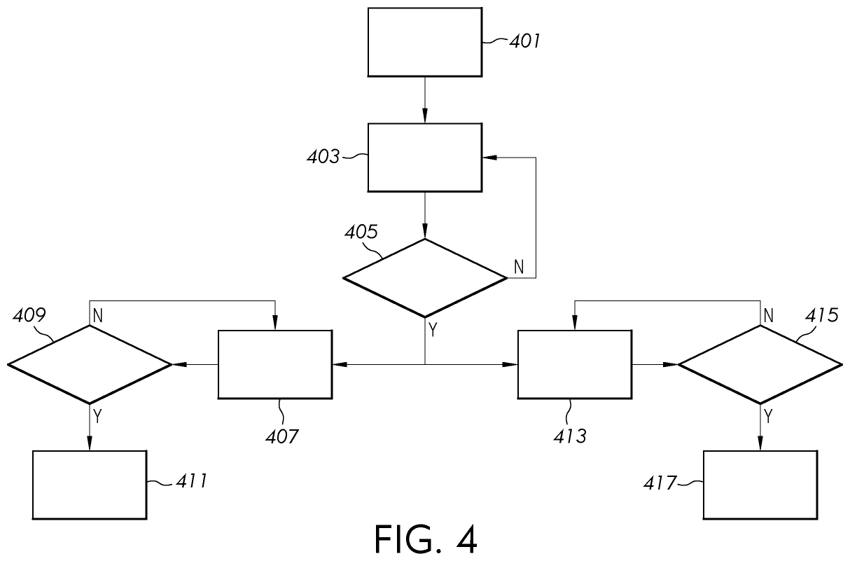

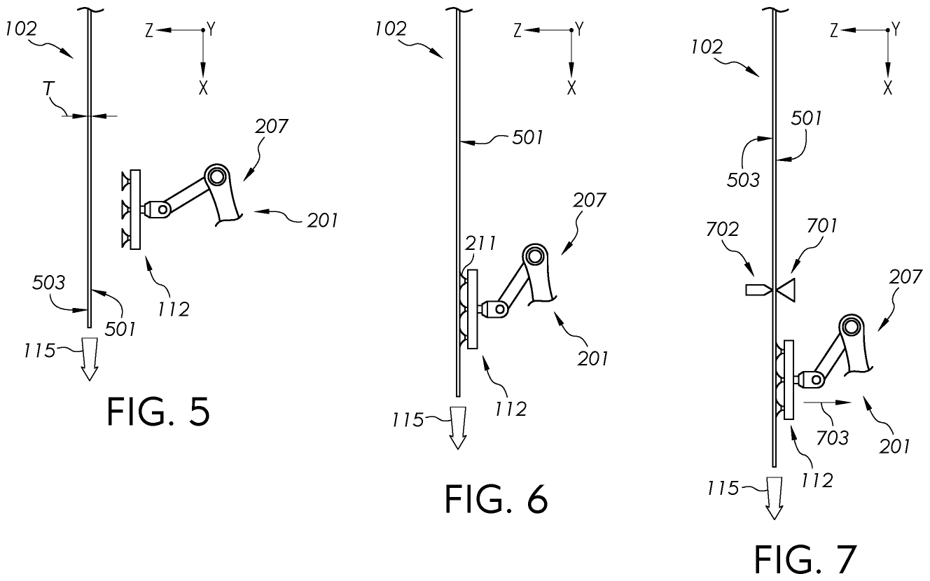

Methods of supporting the ribbon 102 will now be discussed with reference to FIGS. 4-9. As shown in FIG. 4, the glass separation procedure can begin at 401. At the beginning of the procedure, as shown in FIG. 5, the ribbon 102 can travel in the downward direction 115. Furthermore, the first controller 309 can send motion instructions 307 to the arm 207 that controls the motion of the gripping device 112 to travel with substantially the same downward velocity component in the direction of the X-axis as the ribbon 102 with no relative motion between the ribbon 102 and the gripping device 112 in the direction of the X-axis.

As shown in FIG. 6, the gripping device 112 can proceed to move toward the ribbon 102 until the gripping device engages the ribbon 102. The suction cups 211 can then be removably attached to the ribbon 102 with the assistance of a vacuum source (not shown) in communication with each of the suction cups 211. Thereafter, the gripping device 211 continues to move together with the ribbon 102 in the direction of the X-axis while the ribbon 102 is gripped with the gripping device 112.

The method then proceeds to step 403 of controlling the force applied by the gripping device 112 to the ribbon 102 in the direction 115 of the X-axis “X”. The motion (e.g, position, velocity and acceleration) of the gripping device 112 of the support device 201 can be controlled to maintain a downward force (Fₓ) in the direction of the X-axis within a first range of forces, wherein the downward force (Fₓ) is applied by the support device (e.g., by way of the gripping device 112) to the ribbon 102. In some embodiments the first range of forces of the downward force (Fₓ) can be from about 5 Newtons to about 70 Newtons although other ranges of forces can be provided in further embodiments. The downward force (Fₓ) can be sensed by the sensor 301 and the sensed force data 305 can then be provided to the second controller 311.

The method then continues to the decision step 405 where the downward force (Fₓ) sensed by the sensor 301 is compared to the first range of forces. If the downward force (Fₓ) is not within the first range of forces, the method loops back to step 403 to continue the process until the downward force (Fₓ) is within the first range of forces. In some embodiments, the second controller 311 can include an algorithm to modify the position, velocity and acceleration of the gripping device 112 to allow the downward force (Fₓ) to be modified to be within the first range of forces, For example, the controlling the support device to maintain the downward force (Fₓ) can comprise controlling a movement of the support device with the second controller 311 in accordance with the equation:

$$M \ddot{x} + {B}_{x} \dot{x} + {K}_{x} x = {F}_{x} - ( {F}_{p u l {l}_{x 1}} + {F}_{p u l {l}_{x 2}} ) - {F}_{r o o t} - ( {F}_{m s {r}_{1}} + {F}_{m s {r}_{2}} ) sin θ - ( {F}_{n o s e} + {F}_{{nose}^{′}} ) sin θ + ( W ) cos θ ,$$

wherein the meaning of the terms of the equation are provided later in the application.

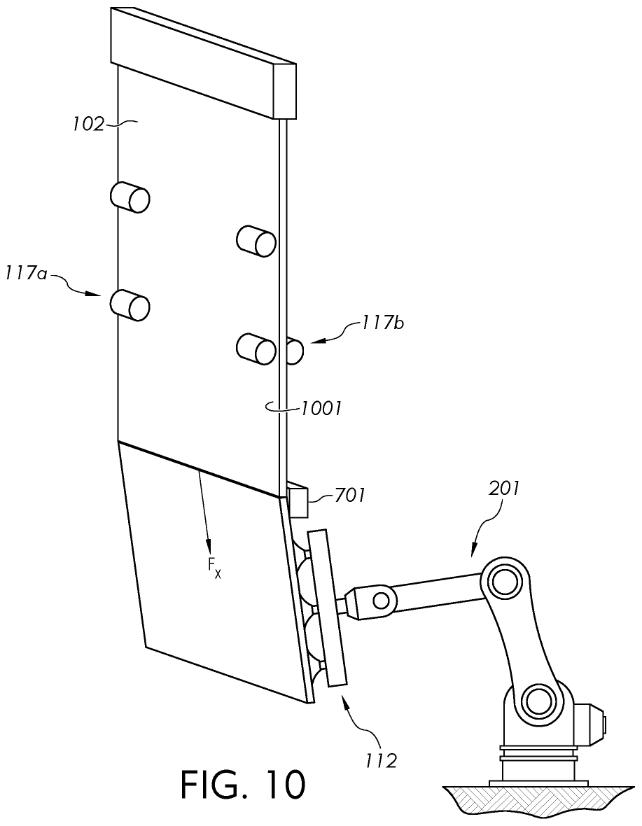

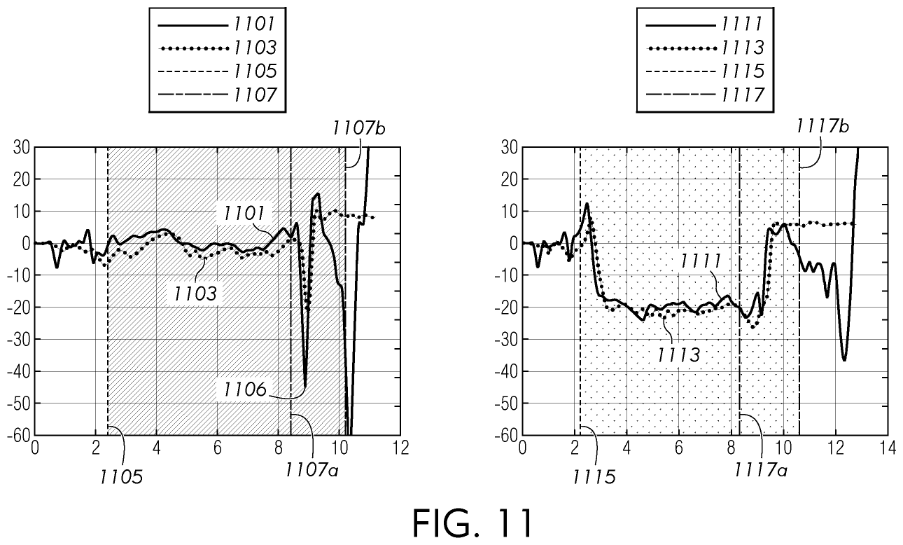

FIG. 10 demonstrates the downward force (Fₓ) being applied by the gripping device 112 to the ribbon 102 to maintain the downward force (Fₓ) within a first range of forces to place the portion 1001 of the ribbon 102 between the pairs of pull rolls 117a, 117b and the gripping device 112 in tension. Both charts of FIG. 11 illustrate the force on the vertical axis as a function of time on the horizontal axis. The chart on the left of FIG. 11 illustrates conventional methods with the downward force (Fₓ) is represented by solid line 1101 and the pull force represented by broken line 1103. Vertical broken line 1105 represents when the ribbon is scored while vertical broken lines 1107a, 1107b represent when the ribbon is bent and separated with the gripping device 112. As can be seen between the broken lines 1105, 1107a, the ribbon is not placed under significant tension that can result in inaccurate measurements of forces and torques with the sensor 301. Furthermore, without placing in tension, one or more force spikes 1106 can occur that can cause slipping at the pull rolls and/or increased wear of the pull rolls. The chart on the right of FIG. 11 illustrates an improved method of the disclosure where the downward force (Fₓ) is represented by solid line 1111 and is kept within a first range of forces. The pull force is represented by broken line 1113 and the vertical broken line 1115 represents when the ribbon is scored. The pulling forces represented by broken lines 1103 and 1113 are the reaction forces when the support device 201 applies the downward forces in the downward direction 115. The downward force (Fₓ) and the pull force are similar since they are measured on the same ribbon but in different directions. The vertical broken lines 1117a, 1117b represent when the ribbon is bent and separated with the gripping device 112. As can be seen between the broken lines 1115, 1117a, the gripping device 112 applies the downward force (Fₓ) to place the ribbon in tension. The tension allows the sensor 301 to accurately measure forces applied by the gripping device 112 to the ribbon and therefore can facilitate balancing forces to avoid disturbances from traveling up the ribbon. Furthermore, as shown, violent force spikes are avoided that helps prevent slipping of the ribbon between the pull rolls and/or reduces accelerated wear of the pull rolls to increase the useful life of the pull rolls.

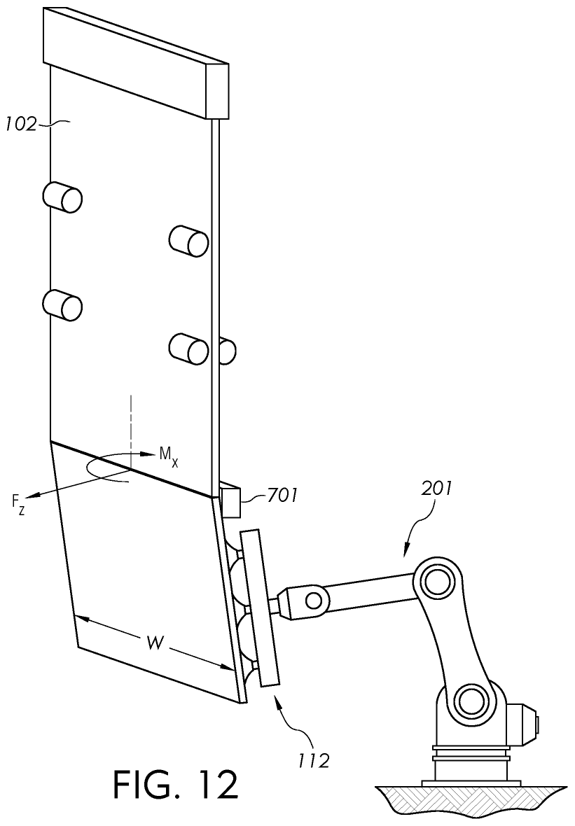

Once the downward force (Fₓ) is determined to be within the first range of forces, the method proceeds simultaneously to steps 407 and 413. Step 407 of the method comprises controlling the interaction between the ribbon 102 and the nosing device 701. As shown in FIG. 7, the support device 201 pulls the ribbon 102 in the direction 703 such that the ribbon engages the nosing device 701. Any misalignment can cause the approaching ribbon 102 to begin touching one lateral side of the elongated nosing device 701 prior to the other lateral side of the nosing device 701. Such touching of opposite lateral sides of the nosing device 701 at different times cause a force differential in a direction of the Z-axis that is uneven and can cause twisting about the X-axis due to an applied moment about the X-axis. As shown in FIG. 12, step 407 can comprise controlling the support device 201 to provide a force profile (F_{z}) in a direction of the Z-axis that is perpendicular to the direction of the X-axis and the direction of the Y-axis. The force profile (F_{z}) can be applied by using the gripping device 112 to force the ribbon 102 against the nosing device 701 across the width “W” of the ribbon 102. Controlling the support device to provide the force profile (F_{z}) further reduces a moment (Mₓ) about the X-axis that the support device applies to the ribbon.

The method can comprise controlling the support device 201 to provide the force profile (F_{z}) by controlling a movement of the support device 201 in accordance with the equation:

$$M \ddot{z} + {B}_{z} \dot{z} + {K}_{z} z = {F}_{z} + ( {F}_{m s {r}_{1}} + {F}_{m s {r}_{2}} ) cos θ + ( {F}_{{nose}^{′}} + {F}_{n o s e} ) cos θ + W sin θ ,$$

wherein the meaning of the terms of the equation are provided later in the application.

As further shown in FIG. 4, decision step 409 determines whether the force profile in the direction of the Z-axis has been reached. Movement of the support device 201 can be further controlled until the profile is reached. Once the force profile in the direction of the Z-axis is reached, the support device 201 also further reduces the moment (Mₓ) as illustrated by step 411 in FIG. 4. The moment (Mₓ) can be further reduced by controlling a movement of the support device in accordance with the equation:

$${I}_{x x} \ddot{ϕ} + {B}_{ϕ} \dot{ϕ} + {K}_{ϕ} ϕ = {M}_{x} + ( {F}_{m s {r}_{1}} {d}_{1} cos θ - {F}_{m s {r}_{2}} {d}_{1}^{′} cos θ ) - ( {F}_{p u l {l}_{y 1}} {d}_{3} + {F}_{p u l {l}_{y 2}} {d}_{3}^{′} ) + ( {F}_{n o s e} {d}_{5} cos θ - {F}_{{nose}^{′}} {d}_{1}^{′} cos θ ) - W {h}_{3} sin θ ,$$

wherein the meaning of the terms of the equation are provided later in the application.

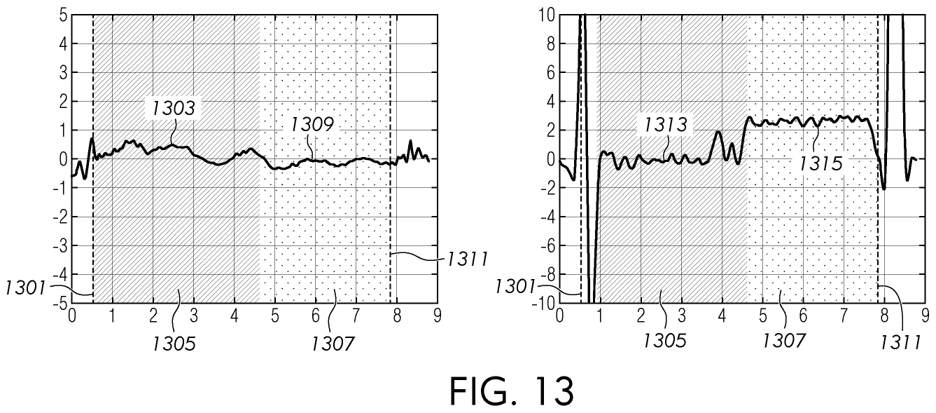

The chart on the right of FIG. 13 illustrates the force profile (F_{z}) on the vertical axis as a function of time on the horizontal axis. The chart on the left of FIG. 13 illustrates the moment (Mₓ) on the vertical axis as a function of time on the horizontal axis. The broken vertical line 1301 in the charts is the moment in time when the scoring of the ribbon begins while the broken vertical line 1311 in the charts is the moment in time when scoring is complete and the bending process begins. Process window 1305 in the charts represents the time before force and moment control was initiated where the elongated nosing device 701 was not aligned with the ribbon. Process window 1307 in the charts represents the time when the force and moment controls are acting to align the elongated nosing device 701 with the ribbon.

Referring to the chart on the right of FIG. 13, as shown by line 1313 in process window 1305, little force is being applied to the ribbon which can result in misalignment of the nosing device with the ribbon. In contrast, as shown by line 1315 in process window 1307 a consistent force can be provided that pulls the ribbon against the ribbon and therefore promotes alignment of the ribbon with the nosing device. In some embodiments, the force profile (F_{z}) can be within a range of forces from about 3 Newtons to about 5 Newtons.

Referring to the chart on the left of FIG. 13, the area 1305 represents conventional methods with a torsion over time represented by line 1303 showing undesired torsion due to the elongated nosing device being misaligned with the ribbon. In contrast, process window 1307 represents methods of the disclosure that demonstrates minimized torsion that would otherwise be applied due to a misaligned elongated nosing device with the ribbon as illustrated by the line 1309 in the area 1307 using methods of the disclosure.

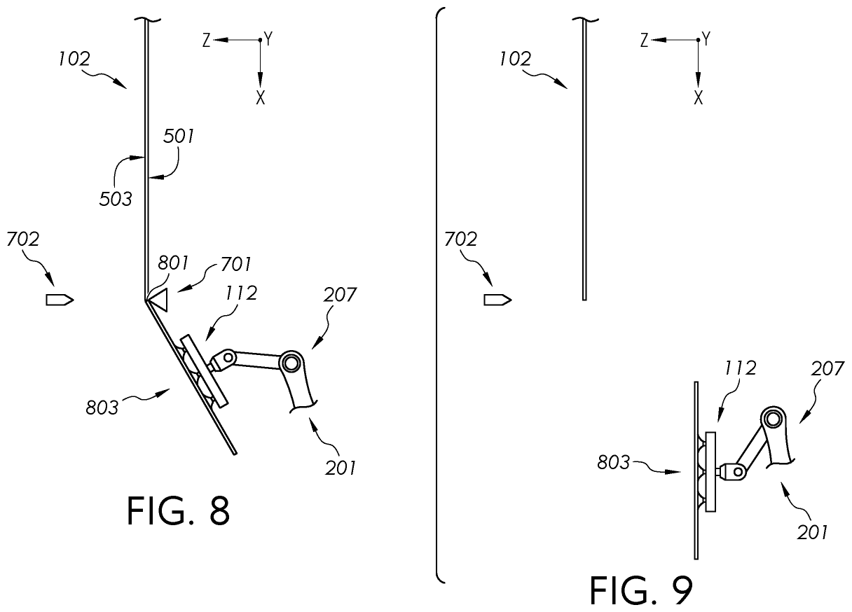

As schematically shown in FIG. 7, once the first major surface 501 of ribbon 102 is pulled against the nosing device 701, a scoring device 702 can score the second major surface 503. The scoring device 702 can comprise a wide range of tools such as a scoring wheel, sharp objector other tools. Once the score line has been created, the support device 201 can bend the ribbon 102 about the nosing device 701 to separate a portion 803 (see FIG. 8) of the ribbon along a crack 801 along the score line and at the point where the nosing device 701 engages the first major surface 501 of the ribbon 102.

As stated previously, after decision step 405, steps 407 and 413 can occur simultaneously. Indeed, controlling the support device to provide the outer (F_{z}) in the direction of the Z-axis and the controlling the support device to reduce the force differential (F_{y}) in the direction of the Y-axis are conducted simultaneously and after the controlling the support device to maintain the downward force (Fₓ) in the direction of the X-axis.

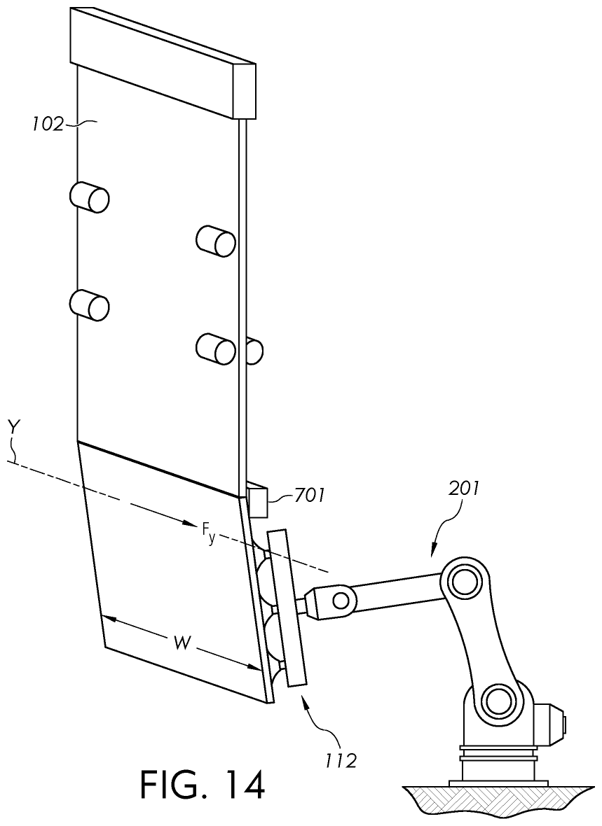

FIG. 14 shows step 413 of controlling the support device 201 to reduce a force differential (F_{y}) in the direction of the Y-axis, wherein the force differential (F_{y}) is applied to the ribbon 102 by the support device 201 across the width “W” of the ribbon 102. Controlling the support device 201 to reduce the force differential (F_{y}) comprises controlling movement of the support device in accordance with the equation:

$$M \ddot{y} + {B}_{y} \dot{y} + {K}_{y} y = {F}_{y} + {F}_{p u l {l}_{y 1}} + {F}_{p u l {l}_{y 2}}$$

wherein the meaning of the terms of the equation are provided later in the application.

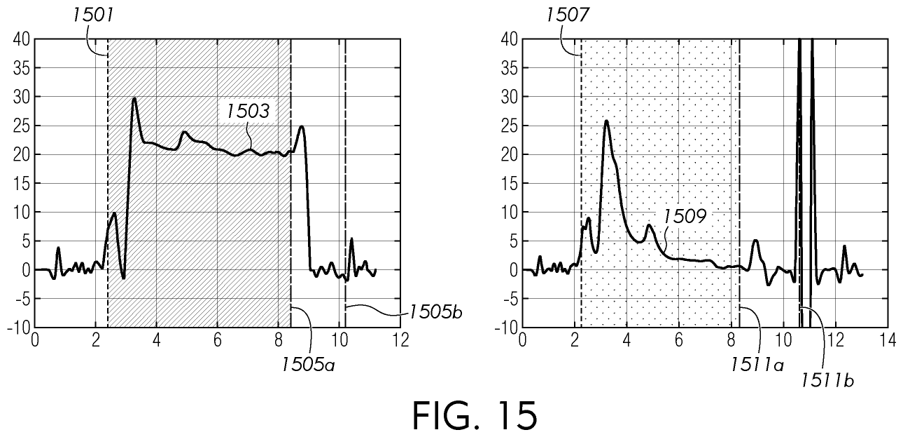

FIG. 15 includes charts with the force differential (F_{y}) in the direction of the Y-axis on the vertical axis as a function of time on the horizontal axis. The chart on the left illustrates the force differential (F_{y}) using conventional methods compared to the force differential (F_{y}) in the chart on the right using features of the disclosure. Vertical broken lines 1501, 1507 illustrate the time when scoring occurs. Vertical broken lines 1505a, 1505b, 1511a, 1511b illustrate bending and separation of the ribbon. As shown by line 1503 conventional techniques result in excessive force differentials (F_{y}) while the line 1509 on the right chart illustrate reduced force differentials (F_{y}).

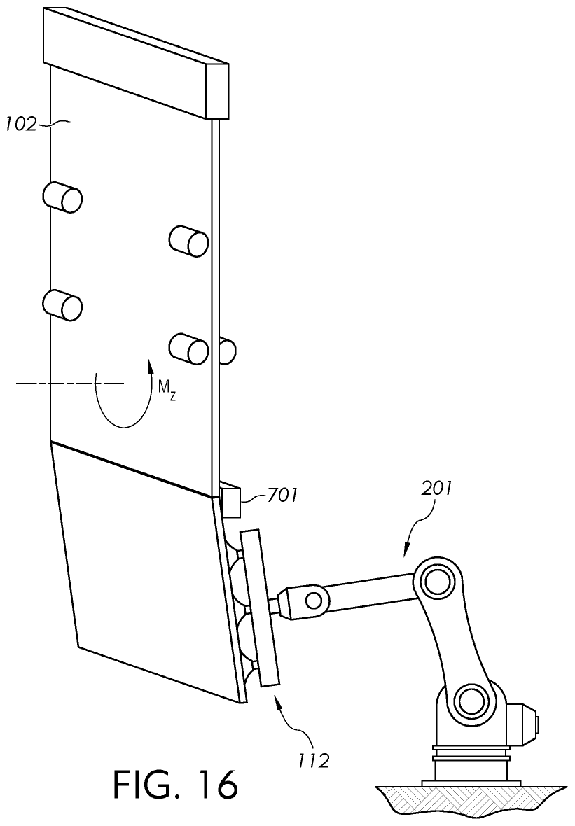

As further shown in FIG. 4, decision step 415 determines whether a force differential (F_{y}) in the direction of the Y-axis has been reached (e.g., within a range of force differentials (F_{y}) and/or when the force differential (F_{y}) reaches about 0 Newtons). If the force differential (F_{y}) in the direction of the Y-axis has not been reached, the method loops around again to step 413 to continue operating the support member 201 until the force differential (F_{y}) in the direction of the Y-axis has been reached. Reducing the force differential (F_{y}) in the direction of the Y-axis reduces the moment (M_{z}) about the Z-axis that the support device 201 applies to the ribbon 102. Further, as shown by step 417 in FIG. 16, The support device 201 can be further controlled to further reduce the moment (M_{z}) by controlling a movement of the support device 201 in accordance with the equation:

$${I}_{zz} \ddot{ψ} + {B}_{ψ} \dot{ψ} + {K}_{ψ} ψ = {M}_{z} + ( {F}_{p u l {l}_{y 1}} {d}_{2} + {F}_{p u l {l}_{y 2}} {d}_{2}^{′} ) + ( {F}_{p u l {l}_{x 1}} {d}_{1} - {F}_{p u l {l}_{x 2}} {d}_{1}^{′} ) + {F}_{n o s e} {d}_{5} sin θ - {F}_{{nose}^{′}} {d}_{5}^{′} sin θ - {F}_{r o o t} {d}_{0} + ( W {h}_{3} cos θ ) ,$$

wherein the meaning of the terms of the equation are provided later in the application.

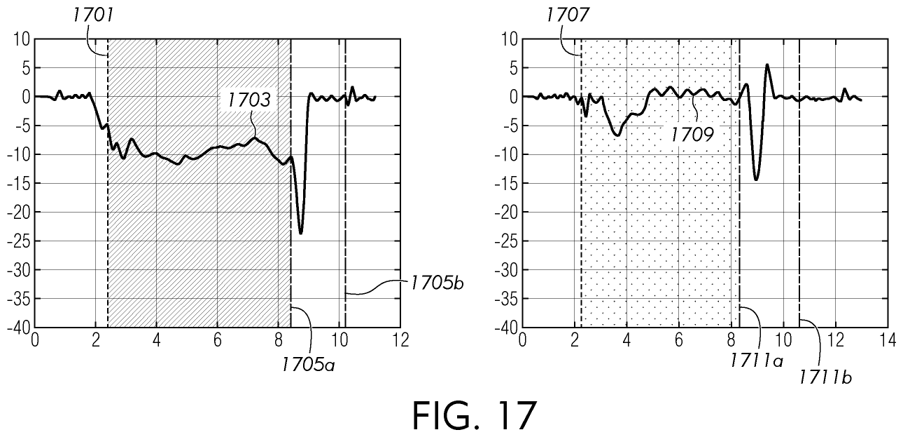

FIG. 17 depicts two charts that illustrate torsion on the vertical axis as a function of time on the horizontal axis. The chart on the left illustrates the moment (M_{z}) about the Z-axis for conventional techniques while the chart on the right illustrates the moment (M_{z}) about the Z-axis using techniques of the disclosure. The vertical broken lines 1701, 1707 demonstrate the time that scoring occurs while vertical broken lines 1705a, 1705b, 1711a, 1711b demonstrate the time where bending and separation of the ribbon occurs. As shown by line 1703, conventional techniques result in an undesirably high moment (M_{z}) about the Z-axis. In contrast, as shown by line 1709 in FIG. 17, the moment (M_{z}) about the Z-axis can be reduced.

Thus, in accordance with aspects of the disclosure, the support device 201 can comprise at least one sensor 301 wherein the method can comprise sensing one or more operating conditions comprising at least one of the downward force (Fₓ), the force profile (F_{z}), the force differential (F_{y}), the moment (Mₓ) about the X-axis, or the moment (M_{z}) about the z-axis with the at least one sensor. The methods can further control the support device 201 in response to the sensed operating conditions to facilitate at least one of controlling the support device 201 to: maintain the downward force (Fₓ), provide the force profile (F_{z}), reduce the force differential (F_{y}), reduce the moment (Mₓ), or reduce the moment (M_{z}).

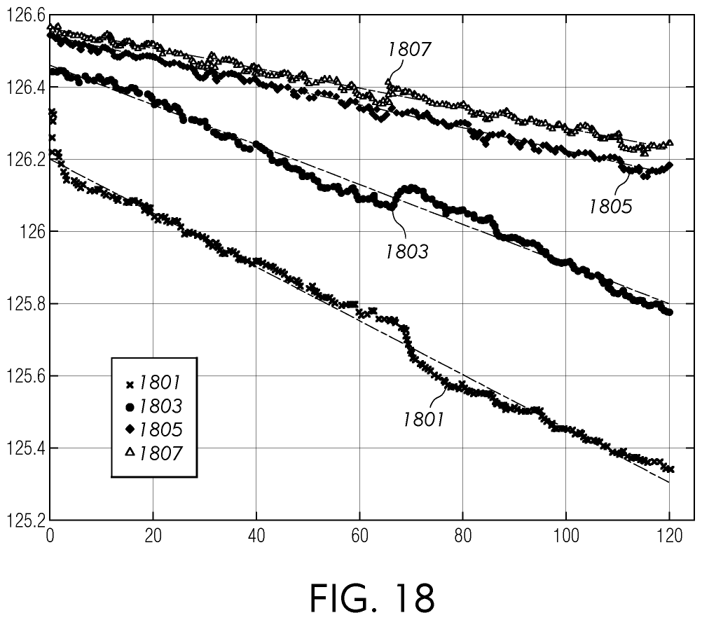

FIG. 18 demonstrates the wear rate of pull rolls wherein the diameter of the rolls appears on the vertical axis as a function of time on the horizontal axis. Plot 1801 represents the wear rate during a conventional operation for a first lateral pair of pull rolls engaging a first lateral side of the ribbon while plot 1803 represents the wear rate during a conventional operation for a second lateral pair of pull rolls engaging a second lateral side of the ribbon. Plot 1805 represents the wear rate during an operation of the disclosure for a first lateral pair of pull rolls engaging a first lateral side of the ribbon while plot 1807 represents the wear rate during an operation of the disclosure for a second lateral pair of pull rolls engaging a second lateral side of the ribbon. Plot 1801 has a greater negative slope than plot 1805 suggesting that operation in accordance with the disclosure reduces the wear rate of the first lateral pair of pull rolls. Furthermore, plot 1803 has a greater negative slope than plot 1807 suggesting that operation in accordance with the disclosure reduces the wear rate of the second lateral pair of pull rolls. Thus, FIG. 18 suggests that methods of the disclosure can reduce the wear rate of the pull rolls, thereby saving time and costs by increasing the useful life of the pull rolls.

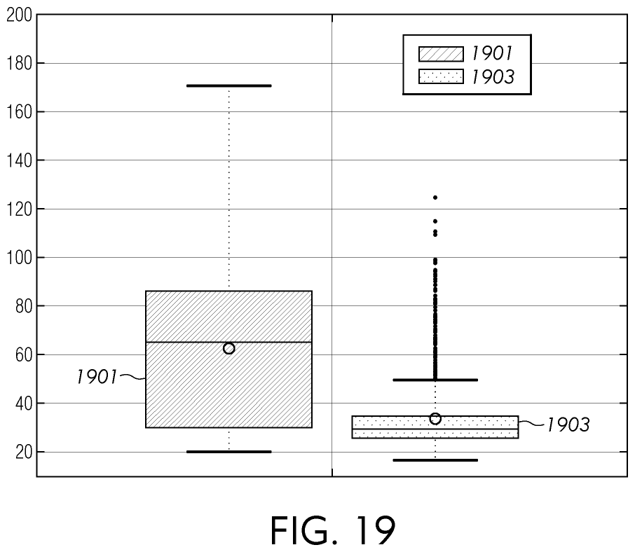

FIG. 19 demonstrates kinetic energy after separation of the portion of the ribbon from the remainder of the ribbon. Bar 1901 demonstrates the kinetic energy in a ribbon after separation using conventional techniques compared to bar 1903 that demonstrates the kinetic energy in the ribbon after separating using techniques of the disclosure. As can be seen, the kinetic energy associated with 1903 is significantly less than the kinetic energy of conventional methods associated with 1901. As such, the techniques of the disclosure can reduce the kinetic energy that occurs during separation and therefore reduce disturbances from traveling up the ribbon to be frozen as defects in the ribbon.

The meanings of the terms in the equations of this application are:
Bₓ, B_{y}, and B_{z} are damping coefficients in the directions of the X-axis, the Y-axis, and the Z-axis, respectively;
B_{ϕ} and B_{ψ} a are rotational damping coefficients of the combination of the support device and the ribbon about the X-axis and the Z-axis, respectively;
d₀ is a distance between a roll force center and a center of the ribbon in the direction of the Y-axis;
d₁ and d₁′ are distances between a ribbon center and a first edge of the ribbon and a second edge of the ribbon, respectively;
d₂ and d₂′ are distances between the score line and a center of the first pull roll and between the score line and a center of the second pull roll, respectively;
d₃ is a distance between a center of the first pull roll and the nosing device at a first lateral side of the ribbon in the direction of the Z-axis;
d₃′ is a distance between a center of the second pull roll and the nosing device at a second lateral side of the ribbon in the direction of the Z-axis;
d₅ and d₅′ are distances between a tooling center and the nosing device at the first lateral side of the ribbon and the second lateral side of the ribbon in the direction of the Y-axis, respectively;
Fₘₛᵣ_{₁}, and Fₘₛᵣ_{₂} are first and second contact forces between a first pull roll and the ribbon and a second pull roll and the ribbon, respectively;
Fₙₒₛₑ is a first lateral side force provided by an elongated nosing device to a first lateral side of the ribbon in the direction of the Z-axis;
Fₙₒₛₑ′ is a second lateral side force provided by the elongated nosing device to a second lateral side of the ribbon in the direction of the Z-axis;
Fₚᵤₗₗ_{ₓ₁} and Fₚᵤₗₗ_{ₓ₂} are first and second forces, respectively, in the direction of the X-axis applied by a first pull roll to the ribbon and a second pull roll to the ribbon, respectively;
Fₚᵤₗₗ_{_{y1}} and Fₚᵤₗₗ_{_{y2}} are a first and second forces, respectively, in the direction of the Y-axis applied by a first pull roll to the ribbon and the second pull roll to the ribbon, respectively;
Fᵣₒₒₜ is a force applied to the ribbon at a location upstream from the first pull roll and the second pull roll;
h₃ is a distance between the center of the ribbon and a tooling center in the direction of the Y-axis;
Iₓₓ and I_{zz} are each a mass moment of inertia of a combination of the support device and the ribbon in the direction of the X-axis and the Z-axis, respectively;
Kₓ, K_{y}, and K_{z} are spring coefficients of the ribbon in the direction of the X-axis, the Y-axis, and the Z-axis, respectively;
K_{ϕ} and K_{ψ} are rotational spring coefficients of the combination of the support device and the ribbon about the X-axis and the Z-axis, respectively;
M is a mass of the ribbon added to a mass of the support device axis;
W is the mass of the support device and the mass of the ribbon multiplied by the force of gravity;
\ddot{x}, \dot{x}, and x are an acceleration, a velocity, and a position, respectively, of the ribbon in the direction of the X-axis;
ÿ, \dot{y}, and y are an acceleration, a velocity, and a position, respectively, of the ribbon in the direction of the Y-axis;
\ddot{z}, ż, and z are an acceleration, a velocity, and a position, respectively, of the ribbon in the direction of the Z-axis;
θ is a pitch angle of the ribbon about the Y-axis;
\ddot{ϕ}, \dot{ϕ}, and ϕ are a roll angular acceleration, a roll angular velocity, and a roll angle, respectively, of the ribbon about the X-axis; and
\ddot{ψ}, \dot{ψ}, ψ, and V) are a yaw angular acceleration, a yaw angular velocity, and a yaw angle, respectively, of the ribbon about the Z-axis.

Directional terms as used herein—for example, up, down, right, left, front, back, top, bottom—are made only with reference to the figures as drawn and are not intended to imply absolute orientation.

It will be appreciated that the various disclosed embodiments may involve features, elements, or steps that are described in connection with that embodiment. It will also be appreciated that a feature, element, or step, although described in relation to one embodiment, may be interchanged or combined with alternate embodiments in various non-illustrated combinations or permutations.

Itis also to be understood that, as used herein the terms “the,” “a,” or“an,” mean “at least one,” and should not be limited to “only one” unless explicitly indicated to the contrary. For example, reference to “a component” comprises embodiments having two or more such components unless the context clearly indicates otherwise. Likewise, a “plurality” is intended to denote “more than one.”

As used herein, the term “about” means that amounts, sizes, formulations, parameters, and other quantities and characteristics are not and need note exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, embodiments include from the one particular value and/or to the other particular value. Similarly, when values are expressed as approximations, by use of the antecedent“about,” it will be understood that the particular value forms another embodiment. Whether or not a numerical value or endpoint of a range in the specification recites “about,” the numerical value or endpoint of a range is intended to include two embodiments: one modified by “about,” and one not modified by “about.” It will be further understood that the endpoints of each of the ranges are significant both in relation to the other endpoint and independently of the other endpoint.

The terms “substantial,” “substantially,” and variations thereof as used herein, unless otherwise noted, are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example, within about 5% of each other, or within about 2% of each other.

Unless otherwise expressly stated, it is in no way intended that any methods set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or“consisting essentially of,” are implied. Thus, for example, implied alternative embodiments to an apparatus that comprises A+B+C include embodiments where an apparatus consists of A+B+C and embodiments where an apparatus consists essentially of A+B+C. As used herein, the terms “comprising” and “including”, and variations thereof shall be construed as synonymous and open-ended unless otherwise indicated.

The above embodiments, and the features of those embodiments, are exemplary and can be provided alone or in any combination with any one or more features of other embodiments provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of embodiments herein provided they come within the scope of the appended claims and their equivalents.

1. A method of supporting a ribbon extending along a direction of an X-axis and along a direction of a Y-axis perpendicular to the direction of the X-axis comprising:
gripping the ribbon with a support device;
controlling the support device to maintain a downward force (Fₓ) in the direction of the X-axis within a first range of forces, wherein the downward force (Fₓ) is applied by the support device to the ribbon;
controlling the support device to provide a force profile (F_{z}) in a direction of a Z-axis that is perpendicular to the direction of the X-axis and the direction of the Y-axis, wherein the force profile (F_{z}) is applied by the ribbon to a nosing device across a width of the ribbon, and wherein controlling the support device to provide the force profile (F_{z}) further reduces a moment (Mₓ) about the X-axis; and
controlling the support device to reduce a force differential (F_{z}) in the direction of the Y-axis, wherein the force differential (F_{y}) is applied to the ribbon by the support device across the width of the ribbon, wherein controlling the support device to reduce the force differential (F_{y}) further reduces a moment (M_{z}) about the Z-axis,
wherein the controlling the support device to provide the force profile (F_{z}) in the direction of the Z-axis and the controlling the support device to reduce the force differential (F_{y}) in the direction of the Y-axis are conducted simultaneously and after the controlling the support device to maintain the downward force (Fₓ) in the direction of the X-axis.

2. The method of claim 1, wherein the support device further comprises at least one sensor, and the method comprises:
sensing one or more operating conditions comprising at least one of the downward force (Fₓ), the force profile (F_{z}), the force differential (F_{y}), the moment (Mₓ) about the X-axis, or the moment (M_{z}) about the z-axis with the at least one sensor; and
controlling the support device in response to the one or more sensed operating conditions to facilitate at least one of controlling the support device to: maintain the downward force (Fₓ), provide the force profile (F_{z}), reduce the force differential (F_{y}), reduce the moment (Mₓ), or reduce the moment (M_{z}).

3. The method of claim 1, wherein the controlling the support device to maintain the downward force (Fₓ) comprises controlling a movement of the support device in accordance with the equation:
$$M \ddot{x} + {B}_{x} \dot{x} + {K}_{x} x = {F}_{x} - ( {F}_{{pull}_{x 1}} + {F}_{{pull}_{x 2}} ) - {F}_{root} - ( {F}_{{msr}_{1}} + {F}_{{msr}_{2}} ) sin θ - ( {F}_{nose} \vert {F}_{{nose}^{′}} ) sin θ + ( W ) cos θ$$
wherein M is a mass of the ribbon added to a mass of the support device, Bₓ is a damping coefficient in the direction of the X-axis, Kₓ is a spring coefficient of the ribbon in the direction of the X-axis, \ddot{x} is an acceleration of the ribbon in the direction of the X-axis, \dot{x} is a velocity of the ribbon in the direction of the X-axis, x is a position of the ribbon along the X-axis, Fₚᵤₗₗ_{ₓ₁} is a first force in the direction of the X-axis applied by a first pull roll to the ribbon, Fₚᵤₗₗ_{ₓ₂} is a second force in the direction of the X-axis applied by a second pull roll to the ribbon, Fₙₒₛₑ is a force applied to the ribbon at a location upstream from the first pull roll and the second pull roll, Fₘₛᵣ_{₁} is a first contact force between a first pull roll and the ribbon, Fₘₛᵣ_{₂} is a second contact force between a second pull roll and the ribbon, Fₙₒₛₑ is a first lateral side force provided by an elongated nosing device to a first lateral side of the ribbon in the direction of the Z-axis, Fₙₒₛₑ′ is a second lateral side force provided by the elongated nosing device to a second lateral side of the ribbon in the direction of the Z-axis, W′ is the mass of the ribbon multiplied by the force of gravity, W is the mass of the support device multiplied by the force of gravity, and θ is a pitch angle of the ribbon about the Y-axis.

4. The method of claim 1, wherein the controlling the support device to reduce the force differential (F_{y}) comprises controlling movement of the support device in accordance with the equation:
$$M \ddot{y} + {B}_{y} \dot{y} + {K}_{y} y = {F}_{y} + {F}_{p u l {l}_{y 1}} + {F}_{p u l {l}_{y 2}} ,$$
wherein M is a mass of the ribbon added to a mass of the support device, B_{y} is a damping coefficient in the direction of the Y-axis, K_{y} is a spring coefficient of the ribbon in the direction of the Y-axis, ÿ is an acceleration of the ribbon in the direction of the Y-axis, \dot{y} is a velocity of the ribbon in the direction of the Y-axis, y is a position of the ribbon along the Y-axis, Fₚᵤₗₗ_{_{y1}} is a first force in the direction of the Y-axis applied by a first pull roll to the ribbon, and Fₚᵤₗₗ_{_{y2}} is a second force in the direction of the Y-axis applied by a second pull roll to the ribbon.

5. The method of claim 1, wherein the controlling the support device to provide the force profile (F) comprises controlling a movement of the support device in accordance with the equation:
$$M \ddot{z} + {B}_{\text{?}} \dot{z} + {K}_{\text{?}} z = {F}_{\text{?}} + ( {F}_{\text{?}} + {F}_{\text{?}} ) cos θ + ( {F}_{\text{?}} + {F}_{\text{?}} ) cos θ + W sin θ ,$$
$$\text{?} \text{indicates text missing or illegible when filed}$$
wherein M is a mass of the ribbon added to a mass of the support device, B_{z} is a damping coefficient in the direction of the Z-axis, K_{z} is a spring coefficient of the ribbon in the direction of the Z-axis, \ddot{z} is an acceleration of the ribbon in the direction of the Z-axis, ż is a velocity of the ribbon in the direction of the Z-axis, z is a position of the ribbon along the Z-axis, Fₘₛᵣ_{₁} is a first contact force between a first pull roll and the ribbon, Fₘₛᵣ_{₂} is a second contact force between a second pull roll and the ribbon, θ a pitch angle of the ribbon about the Y-axis, Fₙₒₛₑ is a first lateral side force provided by an elongated nosing device to a first lateral side of the ribbon in the direction of the Z-axis, Fₙₒₛₑ′ is a second lateral side force provided by the elongated nosing device to a second lateral side of the ribbon in the direction of the Z-axis, and W is the mass of the support device multiplied by the force of gravity.

6. The method of claim 1, wherein the controlling the support device to reduce the moment (Mₓ) comprises controlling a movement of the support device in accordance with the equation:
$${I}_{x x} \ddot{ϕ} + {B}_{ϕ} \dot{ϕ} + {K}_{ϕ} ϕ = {F}_{x} + ( {F}_{m s {r}_{1}} {d}_{1} cos θ - {F}_{m s {r}_{\text{?}}} {d}_{1}^{′} cos θ ) - ( {F}_{p u l {l}_{y 1}} {d}_{\text{?}} + {F}_{p u l {l}_{y 2}} {d}_{\text{?}}^{′} ) + ( {F}_{\text{?}} {d}_{\text{?}} cos θ - {F}_{\text{?}} {d}_{\text{?}}^{′} cos θ ) - {Wh}_{\text{?}} sin θ ,$$
$$\text{?} \text{indicates text missing or illegible when filed}$$
wherein Iₓₓ is a mass moment of inertia of a combination of the support device and the ribbon in the direction of the X-axis, B_{ϕ} is a rotational damping coefficient of the combination of the support device and the ribbon about the X-axis, K_{ϕ} is a rotational spring coefficient of the combination of the support device and the ribbon about the X-axis, \ddot{ϕ} is a roll angular acceleration of the ribbon about the X-axis, \dot{ϕ} is a roll angular velocity of the ribbon about the X-axis, ϕ is a roll angle of the ribbon about the X-axis, Fₘₛᵣ_{₁} is a first contact force between a first pull roll and the ribbon, Fₘₛᵣ_{₂} is a second contact force between a second pull roll and the ribbon, d₁ is a distance between a ribbon center and a first edge of the ribbon, d₁″ is a distance between the ribbon center and a second edge of the ribbon, θ is a pitch angle of the ribbon about the Y-axis, Fₚᵤₗₗ_{_{y1}} is a first force in the direction of the Y-axis applied by a first pull roll to the ribbon, Fₚᵤₗₗ_{_{y2}} is a second force in the direction of the Y-axis applied by a second pull roll to the ribbon, d₂ is a distance between a center of the first pull roll and the nosing device at a first lateral side of the ribbon in the direction of the Z-axis, d₃′ is a distance between a center of the second pull roll and the nosing device at a second lateral side of the ribbon in the direction of the Z-axis, Fₙₒₛₑ is a first lateral side force provided by an elongated nosing device to a first lateral side of the ribbon in the direction of the Z-axis, Fₙₒₛₑ′ is a second lateral side force provided by the elongated nosing device to a second lateral side of the ribbon in the direction of the Z-axis, d₅ is the distance between a tooling center and the nosing device at the first lateral side of the ribbon in the direction of the Y-axis, d₅′ is the distance between a tooling center and the nosing device at the second lateral side of the ribbon in the direction of the Y-axis, W is the mass of the support device multiplied by the force of gravity, and h₃ is a distance between the ribbon center and the tooling center in the of the Y-axis.

7. The method of claim 1, wherein the controlling the support device to reduce the moment (M_{z}) comprises controlling a movement of the support device in accordance with the equation:
$${I}_{zz} \ddot{ψ} + {B}_{ψ} \dot{ψ} + {K}_{ψ} ψ = {M}_{z} + ( {F}_{p u l {l}_{y 1}} {d}_{2} + {F}_{p u l {l}_{y 2}} {d}_{2}^{′} ) + ( {F}_{p u l {l}_{x 1}} {d}_{1} - {F}_{p u l {l}_{x 2}} {d}_{1}^{′} ) + {F}_{n o s e} {d}_{5} sin θ - {F}_{\text{?}} {d}_{5}^{′} sin θ - {F}_{r o o t} {d}_{0} + ( W {h}_{3} cos θ ) ,$$
$$\text{?} \text{indicates text missing or illegible when filed}$$
wherein I_{zz} is a mass moment of inertia of a combination of the support device and the ribbon in the direction of the Z-axis, B_{ψ} a rotational damping coefficient of the combination of the support device and the ribbon about the Z-axis, K_{ψ} is a rotational spring coefficient of the combination of the support device and the ribbon about the Z-axis, \ddot{ψ} is a yaw angular acceleration of the ribbon about the Z-axis, \dot{ψ} is a yaw angular velocity of the ribbon about the Z-axis, ψ is a yaw angle of the ribbon about the Z-axis, Fₚᵤₗₗ_{_{y1}} is a first force in the direction of the Y-axis applied by a first pull roll to the ribbon, Fₚᵤₗₗ_{_{y2}} is a second force in the direction of the Y-axis applied by a second pull roll to the ribbon, Fₚᵤₗₗ_{ₓ₁} a first force in the direction of the X-axis applied by the first pull roll to the ribbon, Fₚᵤₗₗ_{ₓ₂} is a second force in the direction of the X-axis applied by the second pull roll to the ribbon, d₂ is a distance between a center of the first pull roll and a score line, d₂′ is a distance between a center of the second pull roll and the score line, d₁ is a distance between a ribbon center and a first edge of the ribbon, d₁′ is a distance between the ribbon center and a second edge of the ribbon, Fₙₒₛₑ is a first lateral side force provided by an elongated nosing device to a first lateral side of the ribbon in the direction of the Z-axis, Fₙₒₛₑ′ is a second lateral side force provided by the elongated nosing device to a second lateral side of the ribbon in the direction of the Z-axis, d₅ is the distance between a tooling center and the nosing device at the first lateral side of the ribbon in the direction of the Y-axis, d₅′ is the distance between a tooling center and the nosing device at the second lateral side of the ribbon in the direction of the Y-axis, θ is a pitch angle of the ribbon about the Y-axis, Fₙₒₛₑ is a force applied to the ribbon at a location upstream from the first pull roll and the second pull roll, d₅ is a distance between a roll force center and a center of the ribbon in the direction of the Y-axis, W is the mass of the support device multiplied by the force of gravity, and b₃ is a distance between the center of the ribbon and a tooling center in the direction of the Y-axis.

8. The method of claim 1, wherein the first range of forces of the downward force (Fₓ) is from about 5 Newtons to about 70 Newtons.

9. The method of claim 14, wherein the force profile (F_{z}) is within a second range of forces from about 3 Newtons to about 5 Newtons.

10. The method of claim 1, wherein the gripping the ribbon with the support device comprises removably attaching the support device to the ribbon with a plurality of suction cups.

11. The method of claim 10, wherein the plurality of suction cups comprises a first plurality of suction cups engaging a first lateral side of the ribbon and a second plurality of suction cups engaging a second lateral side of the ribbon opposite the first lateral side.

12. The method of claim 11, further comprising placing the ribbon in tension across a width of the ribbon by biasing the first plurality of suction cups away from the second plurality of suction cups.

13. The method of claim 1, wherein the ribbon comprises at least one of a glass-based ribbon or a ceramic-based ribbon.

14. The method of claim 1, further comprising scoring a major surface of the ribbon across the width of the ribbon and along the nosing device while contacting the ribbon with the nosing device.

15. The method of claim 1, wherein the ribbon comprises a thickness of from about 0.2 mm to about 1.5 mm.

16. The method of claim 1, wherein the ribbon moves in the direction of the X-axis during the gripping of the ribbon with the support device.

17. The method of claim 16, wherein the ribbon is formed from a quantity of molten material at a location upstream from where the ribbon is gripped with the support device.
